(19) United States
(12) Patent Application Publication
(10) Pub. No.: US 2007/0245399 A1
(43) Pub. Date: Oct. 18, 2007

(54) System and method for assessing electronic program guide information

(76) Inventor: Joel Espelien, San Diego, CA (US)

Correspondence Address: PATENTS+TMS, P.C., 2849 W. ARMITAGE AVE., CHICAGO, IL, 60647, US

(21) Appl. No.: 11/706,481

(22) Filed: Feb. 15, 2007

Related U.S. Application Data
(60) Provisional application No. 60/786,222, filed on Mar. 27, 2006.

(51) Int. Cl. H04N 7/173; H04N 5/445; G06F 13/00

(52) U.S. Cl. 725/133; 725/39; 725/37

(57) ABSTRACT

A system and a method for accessing electronic program guide information are provided. Media content and/or the electronic program guide information is provided by multiple sources via one or more networks. The media content and/or the electronic program guide information is received by a terminal and/or a database. The database stores and/or saves an electronic program guide which accesses the electronic program guide information from the sources and/or the database. The electronic program guide and/or the terminal arrange, sort and/or organize the electronic program guide information from the various sources by information relating to a user of the terminal. The electronic program guide and/or the terminal arrange and/or organize the electronic program guide information based on information of the media content. The electronic program guide and/or the terminal identify and/or match the electronic program guide information about the media content with information and/or data of the user. The electronic program guide is organized and/or is arranged to satisfy interests, preferences and/or tastes of the user.

This application claims the benefit of U.S. Provisional Application Ser. No. 60/786,222, filed Mar. 27, 2006.

### BACKGROUND OF THE INVENTION

The present invention generally relates to a system and a method for accessing electronic program guide (hereinafter “EPG”) information. More specifically, the present invention relates to a system and a method for accessing EPG information and/or media content via a terminal. One or more sources may transmit, may transfer and/or may send the EPG information and/or the media content to the terminal and/or to a database. The sources may transmit, may transfer and/or may send the EPG information and/or the media content to the terminal and/or the database via a first network, a second network and/or a server. A user may access the EPG information via the terminal to identify, to access, to receive and/or to consume the media content from the sources. The terminal may filter, may manipulate and/or may organize the EPG information based on preferences, tastes and/or information relating to the user. Furthermore, the terminal may filter, may manipulate and/or may organize the EPG information based on information and/or data relating to the media content.

It is generally known, for example, that a user displays, accesses, obtains and/or views an EPG via a terminal over a network. The EPG displays, identifies and/or provides a list in a text form or a graphical form of media content available and/or accessible from a source. The EPG has a set of displays and/or a set of screens which may be layered and/or may be combined with the media content itself. Typically, the source is a content provider, such as, for example, a cable television provider and/or a satellite television provider. Further, the terminal is, traditionally, a set-top receiver which is in communication with the content provider and/or is connected to an output means, such as, for example, a display, a television, a monitor and/or the like. Generally, the terminal is provided by a first content provider which transmits a first type of media content to the terminal.

It is also generally known that the first content provider may transmit and/or may send multiple stations and/or channels of the media content. The first content provider may transmit and/or may send an EPG which has information about the stations and/or the channels of the media content. The user of the terminal may subscribe to and/or may purchase a portion of the stations and/or the channels of the media content. The terminal may organize and/or may arrange the EPG by a time, a channel, a station, and/or a date of the media content. The EPG may list the media content on the channels and/or the stations provided by the source. The user may display and/or may view EPG information only for the channels and/or the stations in which the user has subscribed to and/or purchased from the content provider.

However, the terminal only receives the EPG information from a first content provider. As a result, the terminal merely outputs an EPG having the EPG information about a first type of media content from a single content provider. Further, the terminal does not filter and/or organize the EPG information by preferences, tastes and/or information of the user. Still further, the terminal does not track uses of the media content and/or uses of categories of the media content by the user. Moreover, the terminal does not filter and/or organize the EPG information by information and/or data relating to the media content. Still further, the terminal does not match the EPG information of the user with the EPG information of the media content.

In addition, it is generally known to download, to display, to access, to obtain and/or to view media content from a database and/or a content service via a terminal over a network. Typically, a user may execute an application of the terminal to locate, to identify and/or to search for the media content in the database and/or the content service. The application may be, for example, a desktop search engine which may create an index of media files which are searchable by the user. However, the desktop search engine only searches media files which have been indexed during and/or before the user conducts a search via the desktop search engine. Further, the desktop search engine is incapable of searching and/or indexing media files and/or media content which may be streamed, may be protected via encryption, may be purged by content rules associated with the content service and/or may be a known but yet-to-be broadcasted media file by a network and/or the content service. Moreover, the desktop search engine does not track usage of media files by the user.

A need, therefore, exists for a system and a method for accessing EPG information. Further, a need exists for a system and a method for accessing EPG information which may be transmitted and/or may be received from multiple sources and/or content providers. Still further, a need exists for a system and a method for accessing EPG information which may have a terminal for receiving, organizing, arranging and/or filtering the EPG information from one or more sources and/or content providers. Moreover, a need exists for a system and a method for accessing EPG information which may have a terminal for receiving, organizing, arranging and/or filtering the EPG information about more than one type of media content. Furthermore, a need exists for a system and a method for accessing EPG information which may have a terminal for tracking usage of the media content. In addition, a need exists for a system and a method for accessing EPG information which may have a terminal for filtering and/or organizing EPG information according to usage of media content and/or other information relating to the media content. Further, a need exists for a system and a method for accessing EPG information which may have a terminal for identifying, locating and/or matching EPG information to interests, preferences and/or tastes of a user.

### SUMMARY OF THE INVENTION

The present invention generally relates to a system and a method for accessing EPG information. The system and the method for accessing the EPG information may have a terminal connected to and/or in communication with a first network and/or a second network. A first source and/or a second source may send and/or may transmit the EPG information and/or media content to the terminal via the first network and/or the second network. The terminal may be connected to and/or may be in communication with a database which may store and/or may save the EPG information and/or the media content. The terminal may sort, may arrange and/or may filter the EPG information about the media content based on information and/or data relating to the media content. In addition, the terminal may match the media content to tastes, preferences and/or interests of a user to output the EPG from the terminal.

In an embodiment of the present invention, a system for a user to access media information is provided. The system has a first network connected to a first media source and a second media source wherein the first media source and the second media source transmit media files via the first network; a second network connected to the first media source and the second media source wherein the first media source and the second media source transmit the media files via the second network; a terminal connected to the first network and the second network; a database connected to the terminal wherein the database stores the media files; and an electronic program guide that identifies the media files stored in the database and the media files available from the first media source and the second media source wherein the electronic program guide allows the user to select one of the media files to consume on the terminal.

In an embodiment, the database stores the electronic program guide.

In an embodiment, the media files transmitted by the first media source are of a different type than the media files transmitted by the second media source.

In an embodiment, the selection of one of the media files to consume on the terminal causes the first source to transmit the selected media file to the terminal.

In an embodiment, the first network and the second network are different types of networks.

In an embodiment, the system for a user to access media information has a graphic user interface that displays the electronic program guide on the terminal and allows the user to select one of the media files.

In an embodiment, the electronic program guide arranges the media files of the electronic program guide based on preferences of the user.

In an embodiment, the electronic program guide arranges the media files of the electronic program guide based on metadata associated with the media files.

In an embodiment, the system for a user to access media information has a server connected to the terminal and the first network wherein the server transmits the electronic program guide to the terminal.

In another embodiment, a method for a user to access media files is provided, the method comprising the steps of: connecting a terminal to a first media source and a second media source; storing media files in a database connected to the terminal wherein the terminal accesses the media files from the first media source and the second media source; generating an electronic program guide stored in the database that identifies the media files stored in the database and the media files accessible from the first media source and the second media source; and displaying a graphic user interface on the terminal wherein the graphic user interface displays the electronic program guide and allows the user to select one of the media files to consume on the terminal.

In an embodiment, the method further comprises the step of transmitting one of the media files from the first media source to the terminal.

In an embodiment, the method further comprises the step of arranging the electronic program guide based on a frequency of consumption by the user.

In an embodiment, the method further comprises the step of arranging the electronic program guide based on a location of the user.

In an embodiment, the method further comprises the step of arranging the electronic program guide using the graphic user interface.

In another embodiment, a system for a user to access media files is provided. The system has a network connected to a first media source and a second media source wherein the first media source and the second media source transmit the media files; a first terminal connected to the network wherein the first terminal is connected to a first database that stores media files; an electronic program guide that identifies the media files available from the first media source and the second media source wherein the electronic program guide arranges a list of the media files wherein the electronic program guide is displayed in a graphic user interface on the first terminal wherein the first graphic user interface allows the first user to select one of the media files to consume on the first terminal; and a second terminal connected to the network wherein the second user receives information regarding the use of the electronic program guide by the first user.

In an embodiment, the second user transmits the electronic program guide from the second terminal to the first terminal via the network.

In an embodiment, the second terminal arranges the electronic program guide.

In an embodiment, the second terminal records the media files chosen from the electronic program guide by the first user.

In an embodiment, the second terminal is located remotely relative to the first terminal.

In an embodiment, the system for a user to access media files has a second database connected to the second terminal wherein the first terminal obtains the electronic program guide from the second database via the network.

It is, therefore, an advantage of the present invention to provide a system and a method for accessing EPG information which may have a terminal for receiving media content and/or the EPG information from a first source and/or a second source.

A further advantage of the present invention is to provide a system and a method for accessing EPG information which receives media content and/or the EPG information of various transmission types, formats, categories and/or genres.

Moreover, an advantage of the present invention is to provide a system and a method for accessing EPG information which may have a first network and/or a second network in communication with and/or connected to a terminal for transmitting and/or for sending the EPG information from a first source and/or a second source.

Yet another advantage of the present invention is to provide a system and a method for accessing EPG information which may have a first database for saving, recording and/or storing the EPG information and/or media content.

Another advantage of the present invention is to provide a system and a method for accessing EPG information which may have a first network and/or a second network for transmitting and/or for sending the EPG information and/or media content from a first source and/or a second source.

Moreover, an advantage of the present invention is to provide a system and a method for accessing EPG information which may have a terminal for organizing, filtering and/or arranging the EPG information about media content based on information relating to the media content.

Yet another advantage of the present invention is to provide a system and a method for accessing EPG information which may have a terminal for organizing, filtering and/or arranging the EPG information based on preferences, tastes and/or information of a user of the terminal.

Another advantage of the present invention is to provide a system and a method for accessing EPG information which may have a terminal for matching the EPG information about the media content with preferences and/or tastes of a user of the terminal.

And, another advantage of the present invention is to provide a system and a method for accessing EPG information which may output an EPG from a database which may be connected to and/or in communication with a terminal.

Moreover, an advantage of the present invention is to provide a system and a method for accessing EPG information about media content from multiple sources and/or multiple networks.

Additional features and advantages of the present invention are described in, and will be apparent from, the detailed description of the presently preferred embodiments and from the drawings.

### BRIEF DESCRIPTION OF THE DRAWINGS

FIG. 1 illustrates a black box diagram of a system for accessing EPG information from multiple sources in an embodiment of the present invention.

FIG. 2 illustrates a black box diagram of a system for accessing EPG information having multiple terminals in an embodiment of the present invention.

### DETAILED DESCRIPTION OF THE PREFERRED EMBODIMENTS

The present invention relates to a system and a method for accessing electronic program guide (hereinafter “the EPG”) information. The system and the method may have a first source and/or a second source which may transmit and/or may send media content and/or the EPG information to a terminal via a first network and/or a second network. The first network and/or the second network may be connected to and/or may be in communication with a server. The terminal may be connected to and/or may be in communication with the server, the first network and/or the second network. The terminal may receive the EPG information and/or the media content from the first source and/or the second source. The terminal may organize, may sort and/or may arrange the EPG information based on information and/or data of the user of the terminal and/or information relating to the media content.

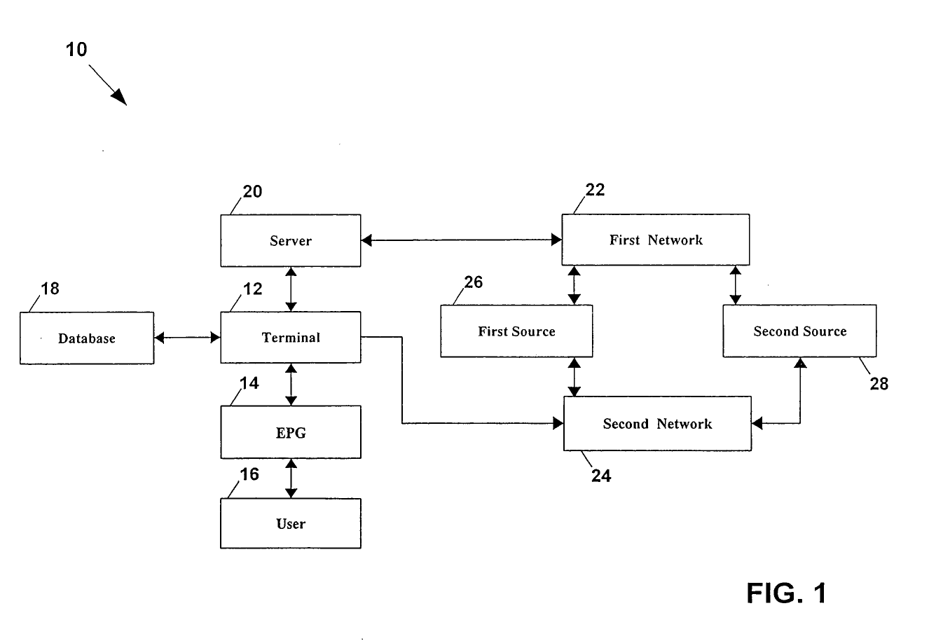

Referring now to the drawings wherein like numerals refer to like parts, FIG. 1 illustrates a system 10 which may have a terminal 12 for accessing EPG information. A user 16 may view, may interact with and/or may access the EPG information via the terminal 12 and/or an EPG 14. The terminal 12 may be connected to and/or may be in communication with a database 18 which may store, may save and/or may record the EPG information, the EPG 14 and/or media content. The terminal 12 and/or the database 18 may be accessible by a server 20, a first network 22 and/or a second network 24. A first source 26 and/or a second source 28 may be connected to and/or may be in communication with the first network 22 and/or the second network 24. To this end, the first source 26 and/or the second source 28 may transmit and/or may send the EPG information and/or the media content to the terminal 12 and/or the database 18.

The terminal 12 may be local and/or may be remote with respect to the server 20 and/or the database 18. The terminal 12 may be, for example, a media content provider terminal, a media content service terminal, a media store terminal and/or the like. Further, the terminal 12 may be, for example, a receiver, such as, for example, a television receiver, a cable receiver, a satellite radio receiver, a radio receiver and/or the like. Still further, the terminal 12 may be a portable device, such as, for example, a personal digital assistant, a computer, a cellular telephone, a 3G mobile device, a 4G mobile device, a wireless broadband device, an internet protocol device, a video cellular telephone, a digital television receiver, a portable digital audio player, a portable digital video player, an “iPod”, a “pocketDISH” player and/or the like. The present invention should not be limited to a specific embodiment of the terminal 12. It should be understood that the terminal 12 may be any media content output device as known to one of ordinary skill in the art.

The terminal 12 may be connected to and/or may be in communication with the first network 22, the server 20 and/or the first network 24. The user 16 may interact with, may view and/or may consume the EPG 14 via the terminal 12. As a result, the user 16 may access the first network 22, the server 20 and/or the database 18 via the terminal 12. The terminal 12 may be local or may be remote from the server 20.

The first network 22 and/or the second network 24 (hereinafter “the networks 22, 24”) may be a wireless network, such as, for example, a wireless metropolitan area network, a wireless local area network, a satellite network, a wireless personal area network, a global standard network, a wireless broadband network, a personal communication system network, a pager-based service network, a general packet radio service, a universal mobile telephone service network, a radio access network and/or the like. The networks 22, 24 may be a fixed network, such as, for example, a cabled network, a permanent network, an internal network and/or the like. Further, the networks 22, 24 may be a temporary network, such as, for example, a modem network, a null modem network and/or the like. In an embodiment, the first network 22 may be connected to and/or may be in communication with the first source 26, and the second network 24 may be connected to and/or may be in communication with the second source 28. In an embodiment, the first network 22 may be a different type of network than the second network 24. For example, the first network 22 may be a wireless broadband network. The first network 22 may be connected to and/or may be in communication with the server 20. In an embodiment, the second network 24 may be in direct communication with and/or may be directly connected to the terminal 12. The present invention should not be limited to a specific embodiment of the networks 22, 24. It should be understood that the networks 22, 24 may be any network capable of transferring, receiving and/or transmitting the EPG, the EPG information and/or the media content as known to one of ordinary skill in the art.

The terminal 12 may be remote with respect to and/or may be remotely connected to the server 20 via the first network 22. The server 20 may stream, may transfer and/or may transmit the EPG 14, the EPG information and/or the media content to the terminal 12 via the first network 22. The EPG 14, the EPG information and/or the media content may be rendered, may be displayed and/or may be reproduced to the user 16 via the terminal 12, respectively. The present invention should not be limited to a specific embodiment of the first network 22. It should be understood that the first network 22 may be any network capable of transferring and/or transmitting the EPG and/or the media content as known to one having ordinary skill in the art.

The first source 26 may send and/or may transmit the EPG 14, the EPG information and/or the media content to the second source 28 via the first network 22 and/or the second network 24. In an embodiment, the second source 24 may receive the EPG information from the first source 26. To this end, the second source 24 may transmit and/or may send the EPG information from the first source 22 and the second source 24 to the terminal 12 and/or the database 18.

Furthermore, the first source 26 and/or the second source 28 (hereinafter “the sources 26, 28”) may exchange, may share and/or may transfer the media content and/or the information, such as, for example, information about the user 16. The terminal 12 may transmit and/or may send the information and/or data to the sources 26, 28. For example, the terminal 12 may transmit and/or may send the EPG 14 and/or the information and/or the data which may be stored in the database 18 to the sources 26, 28.

The sources 26, 28 may be a media station, a media content provider, a media content library, a media exchange provider and/or the like. The media station may be, for example, a television station, a radio station, a streamed radio source, a streamed video source, a satellite radio station and/or the like. The media content provider may be, for example, a cable television provider, a terrestrial digital broadcast provider, a satellite television provider, a satellite radio provider, an internet radio provider, a broadband network provider, a streaming audio and/or video provider and/or the like. The media content library may be a media content retailer and/or distributor such as, for example, a media store, a file-sharing store, an online media distributor and/or the like. It should be understood that the sources 26, 28 may be any source capable of transferring the media content and/or the EPG information to the terminal 12 and/or to the database 18.

In an embodiment, the first source 26 may be different than the second source 28. For example, the first source 26 may be a media station, and the second source 28 may be a media content provider. In an embodiment, the first source 26 may be a different type of source, such as, for example, a different type of media content provider. In such an embodiment, the first source 26 may be a first satellite television provider, and the second source 28 may be a second satellite television provider.

The first source 26 may transmit and/or may send a first type and/or a first format of the media content and/or the EPG information. The second source 28 may transmit and/or may send a second type and/or a second format of the media content and/or the EPG information. The second type and/or the second format may be different than the first format of the media content and/or the EPG information. The terminal 12 may display and/or may output the EPG 14 based on the first format and/or the first type and the second format and/or the second type of the media content and/or the EPG information.

The EPG 14, the media content and/or the EPG information may be transmitted, may be shared and/or may be transferred between the terminal 12 and the sources 26, 28 in a communication protocol. The communication protocol may be a data networking or broadcast protocol, such as, FTP, RTP, RTSP, ASF, DVB, ATSC, ISDB-T, SIP, HTTP, IMAP, IRC, NNTP, POP3, SIP, SMTP, SNMP, SSH and/or the like. The present invention should not be limited to a specific communication protocol. It should be understood that the media content and/or the EPG information may be shared and/or may be transferred between any number of terminals and/or any number of the sources as known to one of ordinary skill in the art.

The database 18 may store, may record and/or may save the media content, the EPG information and/or the EPG 14. The media content may be digital media files, such as, for example, audio signals, video frames, data feeds, data streams, musical compositions, radio programs, audio books, audio programs, television programs, audio or video commercials or advertisements, satellite television programs, public access programs, movies, music videos, animated works, video programs, video games and/or soundtracks and/or video tracks of audiovisual works, dramatic works, film scores and/or an operas and/or the like. Further, the data may be based on, may correspond to and/or may be associated with the digital media files. The present invention should not be limited to a specific embodiment of the data and/or the digital media files. It should be understood that the data and/or the digital media files may be any data and/or any digital media file, respectively, as known to one of ordinary skill in the art.

Each digital media file which may be stored in the database 18 may have, for example, metadata. The metadata may be, for example, a communication and/or information which may be associated with, may relate to and/or may correspond to a digital media file and/or the terminal 12. The communication may be, for example, text, a graphic, a voice recording, a video recording, a conferencing recording, a comment, a note, a review, a correspondence, a commentary, a message, a discussion, a notice, a bulletin, a memorandum, news and/or the like which may be related to, may be associated with and/or may be based on the media content and/or the digital media file.

The information may be, for example, a name of the digital media file, a type of digital media file and/or the like. The type of digital media file may be, for example, a musical composition, a radio program, an audio book, an audio program, a television program, a commercial or other advertisement, a movie, a music video, an animated work, a video program, a video game and/or a soundtrack and/or a video track of an audiovisual work, a dramatic work, a film score and/or an opera and/or the like. Further, the information may have limitations to availability and/or consumption of the media content and/or the digital media file. The limitations may be based on and/or may correspond to geographical boundaries, licensing rights, distribution regulations or public laws or regulations. The information and/or the limitations may identify permitted locations and/or permitted times for transmitting, for receiving, for consuming and/or for viewing the media content and/or the digital media file.

Still further, the information may be, for example, a year of the digital media file, an artist associated with the digital media file, a publisher or a copyright owner of the digital media file, a genre associated with the digital media file and/or a length of time of the digital media file. Moreover, the information may be, for example, a content rating of the digital media file, a language associated with the digital media file, a key word associated with the digital media file, a review of the digital media file, a source of the digital media file and/or the like. The present invention should not be limited to a specific embodiment of the communication, the information and/or the limitations of the metadata. It should be understood that the communication, the information and/or the limitations may be any communication, information and/or any limitations, respectively, as known to one of ordinary skill in the art.

The terminal 12 and/or the database 18 may output the EPG 14, the EPG information and/or the media content. The EPG 14 may have a list of media content items, an interactive application for identifying media content items by, for example, a hierarchical category, a user search criteria and/or the like. The EPG 14 may search, may organize, may locate, may identify, may recommend, may navigate and/or may select the media content, the digital media files and/or the metadata stored in the database 18.

The EPG 14 may have a graphical user interface (hereinafter “GUI”) for displaying availability information corresponding to and/or based on the media content, the digital media files and/or the metadata. The availability information may display the permitted times of, the permitted locations of, the permitted formats, and/or available sources of the media content and/or the digital media files. Information about the media content and/or the digital media files which may be available from the terminal 12 may be identified and/or may be displayed by the EPG 14 using the GUI. The GUI may display the availability information in a display format, such as, for example, rows and/or columns. Alternatively, the GUI may display information based on graphical icons representing content elements, based on a hierarchical display, or based on displaying a single set of preferred responses based on search criteria entered by the user 16.

Further, the GUI may display the availability information in two dimensions or three dimensions. The GUI may be presented as a persistent element of a display screen or may be presented as an overlay, a transparency, a pop-up display, a ticker-tape scroll bar, a picture-in-picture display and/or the like. Presentation of the GUI may allow the user 16 to view the availability information while continuing to view the media content. Further, the GUI may be formatted, may be displayed and/or rendered in a standard format, such as, for example, XML, RDF, RSS, MathML, XHTML, SVG, Flash, SMIL, LASER, cXML and/or the like. It should be understood that the EPG, the display format of the GUI and/or the standard data format of the GUI may be any guide application, any display format and/or any standard data format, respectively, as known to one having ordinary skill in the art.

The terminal 12 may access, may receive, may output and/or may display the EPG 14 via the networks 22, 24 and/or the server 20. The user 16 may browse, may view and/or may identify the EPG 14, the media content, the digital media files and/or the metadata stored in the database 18 with the GUI of the terminal 12. The user 16 may select and/or may access and/or may consume the EPG 14, the media content, the digital media files and/or the metadata stored in the database 18 via the GUI of the terminal 12.

The user 16 may consume the media content and/or the EPG information by viewing, listening to, interacting with, reading, manipulating, modifying, displaying and/or broadcasting the media content and/or the EPG information. In an embodiment, the user 16 may read the EPG information and/or the metadata and view the media content. In addition, the user 16 may read and/or may review the EPG information and/or the metadata prior to consuming the media content. To this end, the user 16 may review the EPG information prior to the terminal 12 and/or the database 18 receiving the media content from the sources 26, 28.

The database 18 and/or the terminal 12 may store and/or may record subscription information and/or purchase information between the user 16 and/or the first source 26 and/or the second source 28. For example, the database 18 and/or the terminal 12 may store and/or may save information relating to the media content which may have been subscribed to and/or purchased from the sources 26, 28 by the user 16. In an embodiment, the database 18 may store payment information, such as, for example, credit card information, bank account information, account information related to the sources 26, 28 and/or billing information. To this end, the user 16 may purchase and/or subscribe to the media content from the sources 26, 28 without inputting and/or submitting payment information.

Furthermore, the database 18 and/or the terminal 12 may store and/or may save information about the user 16. The information may be biographical information, such as, for example, age, citizenship, location, residence, sex, race, native language, religion, interests, activities and/or the like. The information may relate to a schedule of the user 16, such as, for example, times and/or dates in which the user 16 may be consuming the media content, times and/or dates which the user 16 may be remote with respect to the terminal 12 and/or the like. The information may be preferences of the user 16, for example, preferred information relating to the media content, such as, for example, preferred types of the media content, preferred formats of the media content, preferred actors, actresses, singers, directors, songwriters, musical bands and/or the like. The information may relate to preferred sporting events, sports' teams, television shows, movies, radio programs, songs, plays, books, singers and/or the like. The information about the user 16 may be any information that may relate to and/or may be associated with the user 16, the media content, the terminal 12, the first source 26 and/or the second source 28.

In addition, the database 18 may store, may save and/or may record information and/or data relating to the media content which may be accessed, may be viewed and/or may be consumed by the user 16. For example, the database 18 may record and/or may store information relating to types, categories and/or titles of the media content which may have been consumed by the user 16. Furthermore, the database 18 may store and/or may record information relating to a frequency of the types, the categories and/or the titles of the media content which may have been consumed by the user 16.

Moreover, the database 18 may store and/or may save, for example, a title, a file name, a type and/or a category of the media content the user 16 may consume at a given time. For example, the database 18 may store information relating to the media content which the user 16 may view, for example, each Monday night at seven o'clock post meridiem. In an embodiment, the database 18 may save and/or may store a most frequently consumed channel, station and/or location of the media content consumed by the user 16.

In another embodiment, the database 18 and/or the terminal 12 may identify times and/or dates that a user frequently consumes the media content, such as, for example, weekday nights, weekend afternoons and/or the like. To this end, the database 18 and/or the terminal 12 may record and/or may save information, tastes and/or preferences of the user 16. The information of the user 16 may be any information and/or data related to the user 16, the metadata and/or the media content as known to one of ordinary skill in the art.

The EPG 14 and/or the terminal 12 may identify and/or may display trends and/or common characteristics in the media content which may be consumed by the user 16. To this end, the database 18 may accumulate and/or may identify characteristics, tastes and/or preferences of the user 16. For example, the database 18 and/or the terminal 12 may identify that the user 16 frequently views and/or consumes a certain type of show, such as, for example, cop shows, dramatic media content featuring violence and/or media content with romantic themes.

The terminal 12 and/or the EPG 14 may access, may control and/or may command the database 18 to locate, to identify and/or to search for the media content, the metadata and/or the EPG information. The terminal 12 and/or the EPG 14 may identify and/or may match the media content which may correspond to and/or may relate to the information of the user 16.

For example, the terminal 12 and/or the EPG 14 may search and/or may locate the media content from the metadata of the media content. The EPG 14 and/or the terminal 12 may output, may display and/or may identify information relating to the media content, such as, for example, a location, a position, a time until transmission, a length of transmission and/or a quality of transmission of the media content. In an embodiment, the terminal 12 and/or the EPG 14 may output and/or may display a characteristic and/or a quality of the media content which may correspond to and/or may relate to the user 16.

The EPG 14 may arrange and/or may sort the EPG information based on information of the user 16. For example, the EPG 14 may arrange and/or may organize the EPG information based on preferences of the user 16, a frequency of consumption by the user 16 and/or other information of the user 16. Furthermore, the EPG 14 may sort, may arrange and/or may organize the EPG information based on information about the media content and/or the metadata, such as, for example, a genre, a format, a length of, a channel number, a frequency of transmission, a time of transmission, a location of transmission and/or the like. In an embodiment, the EPG 14 may match the information of the user 16 with the information of the media content by, for example, relevancy, potential interest level of the user 16 and/or other criteria that may relate to and/or may be associated with the user 16 and/or the media content.

In an embodiment, the EPG 14 may locate and/or may identify the EPG information about a first media content and a second media content. The first media content may be received by the terminal 12 from the first source 26. The terminal 12 and/or the database 14 may receive the second media content via the second source 28. The first media content and the second media content may be associated with and/or relate to the information of the user 16, such as, for example, a preferred sports team of the user 16. The first media content may be a different type of media content than the second media content. For example, the first type of media content may be a live radio transmission of a sporting event of a preferred sports team of the user 16. The second type of media content may be, for example, a live video transmission of the sporting event of the preferred sports team of the user 16. The EPG 14 may locate and/or identify the first media content and the second media content as, for example, relating to a same sporting event. The user 16 may consume the first media content and the second media content via the terminal 12.

Moreover, the terminal 12 and/or the EPG 14 may display and/or may identify the EPG information about the media content which may be personalized for the user 16. More specifically, the terminal 12 and/or the EPG 14 may organize, may sort, may arrange and/or may identify the EPG information which may match and/or may correspond to the tastes, preferences and/or information of the user 16. The EPG 14 and/or the terminal 12 may identify and/or may locate the EPG information about the media content which relates to and/or may be associated with the information of the user 16, such as, for example, a characteristic of and/or a trend of consumption of the media content by the user 16. The user 16 may access the EPG 14 to arrange the EPG information by, for example, viewing habits of the user 16, such as, for example, the media content frequently viewed by the user 16. The EPG 14 and/or the terminal 12 may organize and/or may arrange the media content relating to the information of the user 16 according to, for example, a time of transmission of the media content. To this end, the EPG 14 may arrange and/or organize, for example, a daily schedule for consuming the media content of the sources 26, 28.

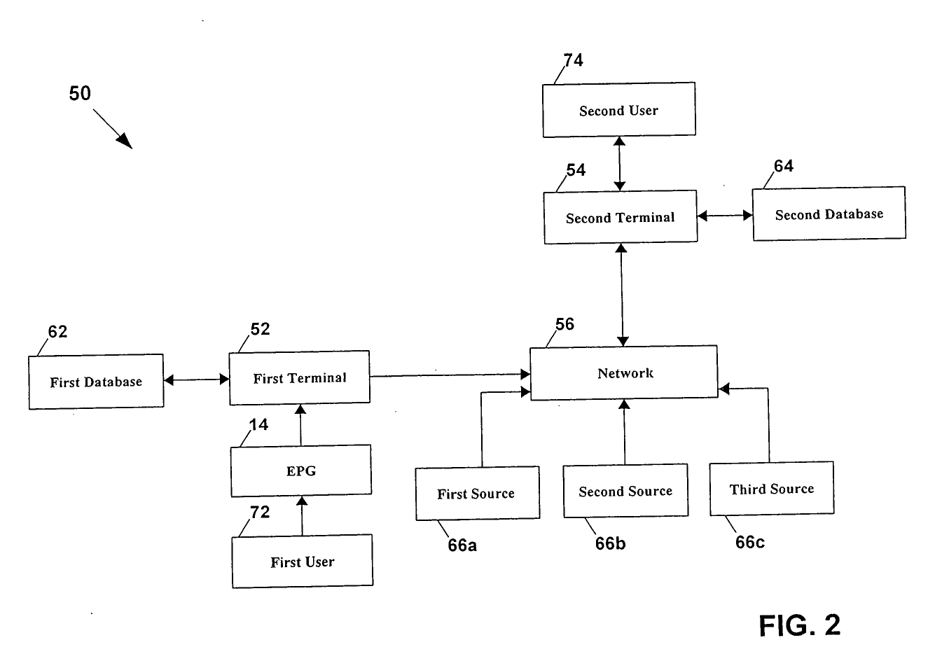

FIG. 2 illustrates an embodiment of the invention having a system 50 which may have a first terminal 52 and a second terminal 54. The first terminal 52 may be connected to and/or may be in communication with the second terminal 54 via a network 56. The first terminal 52 may be remotely located with respect to the second terminal 54. A first database 62 may be connected to and/or may be in communication with the first terminal 52. A second database 64 may be in communication with and/or may be connected to the second terminal 54. As a result, the first database 62 may be connected to and/or in communication with the second database 64.

A first source 66a, a second source 66b and/or a third source 66c (hereinafter “the sources 66a-66c”) may transfer and/or may transmit the media content, the metadata, the EPG information and/or the EPG 14 via the network 56. The first source 66a may be remote with respect to the second source 66b and/or the third source 66c. The sources 66a-66c may transfer and/or may send different transmissions, such as, for example, different types of the media content, different formats of the media content and/or different forms of the media content. The present invention should not be limited to a specific number of sources.

The sources 66a-66c may transfer and/or may send the media content, the metadata, the EPG information and/or the EPG 14 to the first terminal 52 and/or the second terminal 54. The first database 62 and/or the second database 64 may store, may record and/or may save the media content, the EPG information and/or the EPG 14. A first user 72 and/or a second user 74 may consume the media content via the EPG 14. For example, the first user 72 and/or the second user 74 may navigate and/or may locate the media content via the EPG 14. The first terminal 52 and/or the second terminal 54 may display and/or may output the media content to the first user 72 and/or the second user 74. The present invention should not be limited to a specific number of users, terminals and/or databases.

In an embodiment, the second terminal 54 may receive the EPG information from the sources 66a-66c and arrange and/or organize the EPG information. To this end, the second user 74 may be, for example, a third-party, such as, for example, a user which collects the EPG information and transmits the EPG 14 and/or the EPG information to multiple terminals, such as, for example, the first terminal 52. The first user 72 may subscribe to and/or may purchase the EPG 14 and/or the EPG information from the second user 74. The EPG information may be, for example, personalized to the first user 72. For example, the second user 74 may receive information from the first user 72 via the network 56. The second user 74 may track and/or may record viewing habits, such as, for example, times and types of the media content consumed by the first user 72.

Alternatively, the first user 72 and the second user 74 may consume the media content. The second user 74 may store and/or may save the EPG 14 on the second database 64 which may relate to and/or may be associated with information and/or a location of the second user 74. The first user 72 may receive the EPG 14 from the second database 64 and/or the second terminal 54 via the network 56. To this end, the first user 72 may consume the EPG and/or the EPG information of the second terminal 54 at a location remote with respect the second terminal 54 and/or the second user 74.

The sources 66a-66c may transmit the EPG information and/or the media content of different formats and/or different transmission types. The terminals 52, 54 may receive the EPG information from the sources 66a-66c. The terminals 52, 54 may store and/or may record the EPG information on the first database 62 and/or the second database 64. The EPG 14 and/or the terminals 52, 54 may organize, may sort and/or may arrange the EPG information based on information of the first user 72, the second user 74 and/or information of the media content. The EPG 14 and/or the terminals 52, 54 may identify and/or may match the EPG information with information and/or data of the first user 72 and/or the second user 74. To this end, the EPG 14 may be, for example, personalized to the first user 72 and/or the second user 74.

It should be understood that various changes and modifications to the presently preferred embodiments described herein will be apparent to those skilled in the art. Such changes and modifications may be made without departing from the spirit and scope of the present invention and without diminishing its attendant advantages. It is, therefore, intended that such changes and modifications be covered by the appended claims.

I claim:

1. A system for a user to access media information, the system comprising:
a first network connected to a first media source and a second media source wherein the first media source and the second media source transmit media files via the first network;
a second network connected to the first media source and the second media source wherein the first media source and the second media source transmit the media files via the second network;
a terminal connected to the first network and the second network;
a database connected to the terminal wherein the database stores the media files; and
an electronic program guide that identifies the media files stored in the database and the media files available from the first media source and the second media source wherein the electronic program guide allows the user to select one of the media files to consume on the terminal.

2. The system of claim 1 wherein the database stores the electronic program guide.

3. The system of claim 1 wherein the media files transmitted by the first media source are of a different type than the media files transmitted by the second media source.

4. The system of claim 1 wherein the selection of one of the media files to consume on the terminal causes the first source to transmit the selected media file to the terminal.

5. The system of claim 1 wherein the first network and the second network are different types of networks.

6. The system of claim 1 further comprising:
a graphic user interface that displays the electronic program guide on the terminal and allows the user to select one of the media files.

7. The system of claim 1 wherein the electronic program guide arranges the media files of the electronic program guide based on preferences of the user.

8. The system of claim 1 wherein the electronic program guide arranges the media files of the electronic program guide based on metadata associated with the media files.

9. The system of claim 1 further comprising:
a server connected to the terminal and the first network wherein the server transmits the electronic program guide to the terminal.

10. A method for a user to access media files, the method comprising the steps of:
connecting a terminal to a first media source and a second media source;
storing media files in a database connected to the terminal wherein the terminal accesses the media files from the first media source and the second media source;
generating an electronic program guide stored in the database that identifies the media files stored in the database and the media files accessible from the first media source and the second media source; and
displaying a graphic user interface on the terminal wherein the graphic user interface displays the electronic program guide and allows the user to select one of the media files to consume on the terminal.

11. The method of claim 10 further comprising the step of:
transmitting one of the media files from the first media source to the terminal.

12. The method of claim 10 further comprising the step of:
arranging the electronic program guide based on a frequency of consumption by the user.

13. The method of claim 10 further comprising the step of:
arranging the electronic program guide based on a location of the user.

14. The method of claim 10 further comprising the step of:
arranging the electronic program guide using the graphic user interface.

15. A system for a user to access media files, the system comprising:
a network connected to a first media source and a second media source wherein the first media source and the second media source transmit the media files;
a first terminal connected to the network wherein the first terminal is connected to a first database that stores media files;
an electronic program guide that identifies the media files available from the first media source and the second media source wherein the electronic program guide arranges a list of the media files wherein the electronic program guide is displayed in a graphic user interface on the first terminal wherein the first graphic user interface allows the first user to select one of the media files to consume on the first terminal; and
a second terminal connected to the network wherein the second user receives information regarding the use of the electronic program guide by the first user.

16. The system of claim 15 wherein the second user transmits the electronic program guide from the second terminal to the first terminal via the network.

17. The system of claim 15 wherein the second terminal arranges the electronic program guide.

18. The system of claim 15 wherein the second terminal records the media files chosen from the electronic program guide by the first user.

19. The system of claim 15 wherein the second terminal is located remotely relative to the first terminal.

20. The system of claim 15 further comprising:
a second database connected to the second terminal wherein the first terminal obtains the electronic program guide from the second database via the network.
